(19) United States
(12) Patent Application Publication
(10) Pub. No.: US 2023/0119577 A1
(43) Pub. Date: Apr. 20, 2023

(54) HIGH ALLOY WELDING WIRE WITH COPPER BASED COATING

(71) Applicant: LINCOLN GLOBAL, INC., Santa Fe Springs, CA (US)

(72) Inventors: Badri K. NARAYANAN, Highland Hts., OH (US); Nathanael M. COLVIN, Ashtabula, OH (US); Alexander J. ZADDACH, Cleveland, OH (US); John Benjamin SCHAEFFER, Rocky River, OH (US)

(21) Appl. No.: 18/045,934

(22) Filed: Oct. 12, 2022

Related U.S. Application Data
(60) Provisional application No. 63/256,290, filed on Oct. 15, 2021.

(51) Int. Cl. B23K 35/02; B23K 35/30

(52) U.S. Cl. CPC B23K 35/0261; B23K 35/302; B23K 35/3093

(57) ABSTRACT

Welding wires may include a high alloy metal core comprising greater than about 10.5 percent by weight of the high alloy metal core of a component selected from aluminum, bismuth, chromium, molybdenum, chromium/molybdenum alloy, cobalt, copper, manganese, nickel, silicon, titanium, tungsten, vanadium, or a combination thereof; and a layer surrounding the high alloy metal core, the layer comprising copper or a copper alloy. Welding methods may include applying an electrical current sufficient to convert a welding wire to a molten state to produce a molten weld material, the welding wire comprising: a high alloy metal core comprising greater than about 10.5% of a component selected from aluminum, bismuth, chromium, molybdenum, chromium/molybdenum alloy, cobalt, copper, manganese, nickel, silicon, titanium, tungsten, vanadium, or a combination thereof; and a layer surrounding the high alloy metal core, the layer comprising copper or a copper alloy; and depositing the molten welding material onto a workpiece.

### CROSS-REFERENCE TO RELATED APPLICATION

This application claims priority to U.S. Provisional Patent Application No. 63/256,290, titled “HIGH ALLOY WELDING WIRE WITH COPPER BASED COATING” filed Oct. 15, 2021, which is incorporated herein by reference.

### FIELD OF THE INVENTION

The present disclosure generally relates to consumable welding electrodes and welding processes utilizing the same.

### BACKGROUND

Welding is a process that has become ubiquitous in industrial usage for a variety of applications. Depending on the process, welding wires may serve as an consumable electrode that function as a source of metal for forming a weld on a workpiece, and a mechanism for providing flux and other weld performance additives. For example, in metal arc welding, an electric arc is created when a voltage is applied between the welding wire (a first electrode) and the workpiece (a second electrode). As electrical current is generated, an arc forms between the electrodes, melting the tip of the welding wire and producing a weld bead of molten metal at the point of contact on the workpiece. In general, the welding wire is continuously fed into the welding system, providing a stream of molten metal that generates the weld on the workpiece.

The chemical composition, physical state, and presence of layers and coatings on the welding wire can all impact a number of weld properties. Welding wire chemical metal composition can alter bead and weld quality in both appearance and mechanical properties, including yield strength, ductility, and fracture toughness. Moreover, the structural properties of the welding wire can also impact other components of the welding system. The feed system and contact tip, for example, experience friction and electrical resistance that is dependent on the properties of the welding wire, which can affect mechanical wear and overall service life of these system components.

### SUMMARY

In an aspect, welding wires disclosed herein may include a high alloy metal core comprising greater than about 10.5 percent by weight of the high alloy metal core of a component selected from aluminum, bismuth, chromium, molybdenum, chromium/molybdenum alloy, cobalt, copper, manganese, nickel, silicon, titanium, tungsten, vanadium, or a combination thereof; and a layer surrounding the high alloy metal core, the layer comprising copper or a copper alloy.

In another aspect, welding methods disclosed herein may include applying an electrical current sufficient to convert a welding wire to a molten state to produce a molten weld material, the welding wire comprising: a high alloy metal core comprising greater than about 10.5 percent by weight of the high alloy metal core of a component selected from aluminum, bismuth, chromium, molybdenum, chromium/molybdenum alloy, cobalt, copper, manganese, nickel, silicon, titanium, tungsten, vanadium, or a combination thereof; and a layer surrounding the high alloy metal core, the layer comprising copper or a copper alloy; and depositing the molten welding material onto a workpiece.

### BRIEF DESCRIPTION OF TH DRAWINGS

Certain embodiments of the present invention may take physical form in certain parts and arrangements of parts, a preferred embodiment of which will be described in detail in the specification and illustrated in the accompanying drawings which from a part hereof, and wherein:

FIG. 1 is an embodiment of a coated wire in accordance with one embodiment.

FIG. 2 is a flow diagram of a non-limiting embodiment of a welding method.

### DETAILED DESCRIPTION

The present disclosure generally relates to consumable welding electrodes and welding processes utilizing the same. Welding wire compositions disclosed herein exhibit reduced contact tip wear and improved electrical properties. Particularly, welding wire compositions disclosed herein include a high alloy core coated with a layer of copper or copper alloy. The layer of copper or copper alloy may form a conductive layer that also exhibits improved compatibility with copper contact tips, while also reducing mechanical and electrical-induced wear.

In arc welding applications, high alloy welding wire may have a number of advantages including fine appearance, corrosion resistance, tarnish resistance, and oxidation resistance at elevated temperature. However, high alloy welding wire often exhibits higher tensile strength and surface hardness that can increase the wear on the wire feeding components of the welding system, which are often composed of softer metals and alloys. Moreover, the conductivity difference between the high alloy wire and the contact tip (often constructed from copper) also contributes to arc formation and burnback that can lead to clogging and feed issues. Despite these drawbacks, high alloy welding wire is often used in the unclad form, or with a non-metal coating such as silicone, to form welds that are naturally corrosion resistant, and have excellent weld appearance and strength.

External layers and coatings and of conductive metals have been employed for a number of welding wires, but can also carry potential disadvantages. Copper coatings, for example, have been used to coat low alloy solid metal and flux-cored welding wires to improve corrosion resistance, enhance conductivity, reduce contact tip deterioration, and lubricate the wire during drawing and feeding through the welding apparatus. However, the use of copper coatings may also be accompanied by a number of disadvantages. Copper metal is soft and tends to create flakes of copper metal during the forced feeding of the wire through the weld system, including through the liner, torch, and contact tip. During passage through each of these components, copper flakes can cause a number of mechanical issues, including the formation of aggregates that form clogs or electrical contact points that can cause hotspots. Worse still, copper flakes may induce a form of liquid metal embrittlement, or “copper cracking” that damages the strength of the weld. During welding, copper flakes may be melted by molten slag and transferred to the weld bead. As the bead metal and cools, copper remains molten and migrates to the grain boundary of the solidified metal. Within the grain boundaries of the weld, the soft copper metal forms weak points that weaken the weld and/or workpiece metal.

Contrary to these findings in the field, welding wire compositions disclosed herein utilize a high alloy metal core surrounded by a layer of copper or copper alloy to form a consumable electrode. The low resistivity of the copper-containing layer permits the transfer of current to the contact tip as the wire is passed through, which reduces torch heat loss and minimizes or eliminates arc formation between the wire and contact tip. Because copper is softer relative to the high alloy metal core of the welding wire, the copper-containing layer also reduces abrasion and mechanical wear on the feeding components of the welding system that are often constructed from similar copper materials. Unexpectedly, the welding wire compositions disclosed herein exhibit similar or greater performance over comparative unclad high alloy wire, while improving contact tip service life and maintaining weld strength without copper cracking.

Welding wire compositions disclosed herein generally include a high alloy metal core having a surrounding copper-containing layer. As used herein, the term “high alloy metal” can refer to an alloy comprising one or more metals and at least 8% (e.g., greater than about 10.5%), by weight, of alloying elements, such as: aluminum, bismuth, chromium, molybdenum, chromium/molybdenum alloys, cobalt, copper, manganese, nickel, silicon, titanium, tungsten, and/or vanadium. The high alloy metal core may include high alloy metal having sufficient conductivity for currents and conditions applied in the selected welding process. In some embodiments, the high alloy core may include high alloy steels containing iron and greater than about 10.5 wt % of a component selected from any one or more of: aluminum, bismuth, chromium, molybdenum, chromium/molybdenum alloys, cobalt, copper, manganese, nickel, silicon, titanium, tungsten, and/or vanadium. High alloy metals may include, for example: stainless steels, maraging steel, Cr—Mo alloy steels, nickel alloys such as 276, 625, 718 nickel alloys, a combination thereof, and/or the like. Welding wire compositions incorporating a high alloy metal core may also include a blend of any of the above alloys, including multi-phase and duplex stainless steels.

In some embodiments, high alloy cores may include, for example, stainless steel compositions containing chromium at a percent by weight (wt %) of the high alloy metal core from about 12 wt % to about 18 wt %. Suitable stainless steels may include one or more common grades (e.g., 200, 300, 400, etc.) of stainless steel, including martensitic, austenitic, or ferritic stainless steels. In some embodiments, the high alloy metal core may be a 300 grade austenitic stainless steel, such as a 302, 303, 304, 316, 310, or 321 grade stainless steel.

The inclusion of a copper-containing layer over a high alloy metal core may also carry advantages during production of the welding wire. For example, the use of a copper or copper alloy coating may function as a lubricant during wire drawing, minimizing or eliminating the need for additional additives or coatings. In some cases, the presence of a copper-containing layer may permit direct draw to a suitable working diameter from a larger stock to produce a welding wire compositions, and at increased speeds relative to unclad stainless steel wire. In some embodiments, the welding wire composition can comprise multiple copper-containing layers. For example, a plurality of copper-containing layers can surround the high alloy metal core.

The one or more copper-containing layers may include copper and copper alloys that are clad or bonded to the high alloy metal core by any appropriate process. In some embodiments, additional coating layers, such as nickel, may be introduced during fabrication of the copper-containing layer that may enhance compatibility with the high alloy metal core. Suitable copper alloys include alloys of copper and one or more of the metals selected from: nickel, zinc, chromium, cadmium, and/or tin. Copper alloys disclosed herein may include copper at a percent by weight (wt %) of the copper alloy up to about 90 wt %, up to about 95 wt %, up to about 99 wt %, or up to about 99.9 wt %. In some embodiments, the copper alloy may include copper at content by percent weight of the alloy ranging from about 60 wt % to about 95 wt %, or about 60 wt % to about 99.9 wt %. In some embodiments, where the welding wire composition comprises a plurality of copper-containing layers, one or more of the copper containing layers can have alternative material composition (e.g., the copper content within a first copper-containing layer of the welding wire composition can be greater than the copper content within a second copper-containing layer).

The selection of copper or copper alloy as a surrounding layer may depend on a number of factors, including welding process type and metal composition of the workpiece. In some cases, depending on the nature of the high alloy metal in the core, the surface tension of the copper-containing layer may be tuned, for example, by modifying the copper content of the alloy to minimize migration of the copper into the grain boundaries of the weld metal. The thickness of the copper-containing layer may also vary depending on the particular application. Welding wire compositions may include a high alloy metal core having a copper-containing layer arranged thereon, where the thickness of the copper-containing layer is greater than about 0.01 μm, greater than about 0.1 μm, greater than about 1 μm, and the like. In some embodiments, the copper-containing layer may have a thickness ranging from about 0.1 μm to about 100 μm.

The copper containing layer may be present at a percent by weight (wt %) of the welding wire ranging from about 0.005 wt % to about 3 wt %, about 0.005 wt % to about 2 wt %, or about 0.005 wt % to about 1 wt %. The copper-containing layer may include up to about 5% of the cross-sectional area of the welding wire, including up to about 0.01% to about 5% of a cross-sectional area of the welding wire in some embodiments.

While a number of solid core welding wire embodiments are disclosed herein, it is also envisioned that the components of the welding wire compositions may also be adapted to produce flux-cored welding wires having a flux material surrounded by a high alloy metal sheath with a copper-coated layer arranged thereon.

Welding wire compositions disclosed herein may be drawn or otherwise manufactured to any suitable diameter for the selected welding process (e.g., 0 to 30 gauge or more). In general, welding methods disclosed herein may include applying an electrical current sufficient to convert a welding wire composition to a molten state, the welding wire including a high alloy metal core, and a copper-containing layer surrounding the high alloy metal core; and depositing the molten droplets onto a workpiece. Welding processes are not regarded as particularly limited and may include gas-metal arc welding processes such as submerged-arc welding (SAW), gas tungsten arc welding (GTAW), gas metal arc welding (GMAW), shielded metal arc welding (SMAW), flux-cored techniques such as Flux-Cored Arc Welding (FCAW), and combinations thereof.

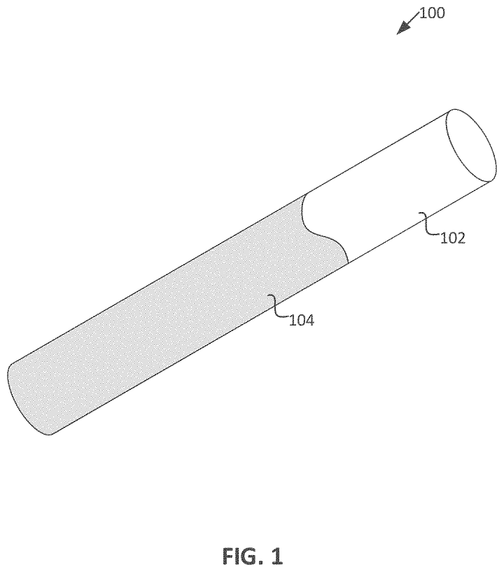

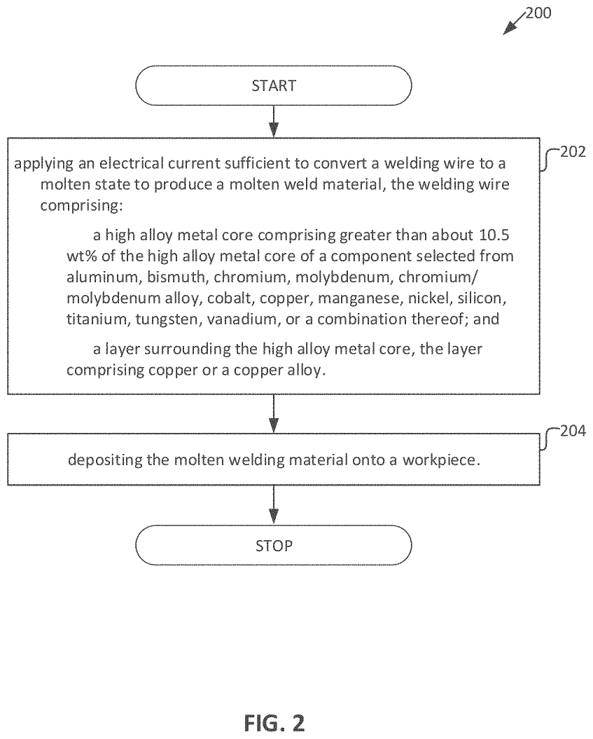

Referring to FIG. 1, an embodiment of a coated welding wire 100 is illustrated that includes a core 102 and a layer 104 surrounding the core. For clarity, a portion of the layer 104 is removed from the coated welding wire 100 depicted in FIG. 1 to illustrate the inner core 102 that is coated along the length of the wire 100 by the layer 104. In embodiments, the core 102 is high alloy metal core, and the layer 104 includes copper or a copper alloy. Referring to FIG. 2, in an embodiment a welding method 200 is illustrated. Step 202 includes applying an electrical current sufficient to convert a welding wire to a molten state to produce a molten weld material, in which the welding wire (e.g., coated welding wire 100) comprises a high alloy metal core (e.g., core 102) comprising greater than about 10.5 wt % of the high alloy metal core of a component selected from: aluminum, bismuth, chromium, molybdenum, chromium/molybdenum alloy, cobalt, copper, manganese, nickel, silicon, titanium, tungsten, vanadium, or a combination thereof; and a layer surrounding the high alloy metal core, comprising copper or a copper alloy. Step 204 includes depositing the molten welding material onto a workpiece.

To facilitate a better understanding of the embodiments of the present invention, the following examples of preferred or representative features are given. In no way should the following examples be read to limit, or to define, the scope of the embodiments.

### EXAMPLES

The following non-limiting examples are provided to further illustrate the embodiments of the present invention. It should be appreciated by those of skill in the art that the techniques disclosed in the examples that follow represent approaches the inventors have found function well in the practice of the embodiments of the present invention, and thus can be considered to constitute examples of modes for its practice. However, those of skill in the art should, in light of the embodiments of the present invention, appreciate that many changes can be made in the specific embodiments that are disclosed and still obtain a like or similar result without departing from the spirit and scope of the embodiments.

### Example 1: Weld Performance of Cu-Coated 302 Grade Stainless Steel

In this example, welds were produced using a copper coated stainless solid wire (Cu-Coated 302) and a comparative unclad 316LSi grade stainless steel (Unclad 316LSi). Both wire samples exhibited a 0.045″ diameter. Testing was performed on an automated arc welding apparatus configured to apply a test weld at a controlled contact tip to work distance (CTWD). The test weld was formed on a 24″ diameter pipe by continuous weld to minimize measurement interference from starting and stopping. Test welds were run until failure, typically indicated by spatter clogging the nozzle and contacting the workpiece. Weld conditions and settings are summarized in Table 1, where welds were made with constant voltage (CV) and pulse.

TABLE 1
Weld conditions for Example 1

| WFS | Voltage | Current | CTWD | Gas |
|---|---|---|---|---|
| 250-450 | 23-28 | 230-270 | ½″-⅝″ | 95%Ar/2%CO₂ |

Weld appearance for the Cu-Coated 302 samples was analyzed alongside the Unclad 316LSi for all conditions surveyed. A range of shielding gas compositions were also tested. Results for testing and conditions are summarized in Table 2, where a rating of 4 is equivalent to the results of the Unclad 302. In general, the bead appearance of the Cu-Coated 302 was coarser in appearance with some superficial pitting, but did not otherwise affect weld strength.

TABLE 2
Summary of weld properties of Cu-Coated
302 under differing gas conditions.

| | Arc | Puddle | Spatter | Bead |
|---|---|---|---|---|
| Gas | Stability | Fluidity | on Plate | Appearance |
| 95%Ar/2%CO₂ | 4 | 4 | 4 | 2 |
| 90%He/7.5%Ar/2.5%CO₂ | 4 | 4 | 2 | 2 |
| 95%Ar/%O₂ | 4 | 4 | 4 | 2 |
| 95%Ar/5%CO₂ | 4 | 4 | 4 | 2 |
| 90%Ar/10%CO₂ | 4 | 4 | 4 | 2 |
| 80%Ar/20%CO₂ | 4 | 4 | 4 | 2 |

### Example 2—Contact Tip Wear Analysis

In this example, contact tip wear rates for Unclad 316LSi and Cu-Coated 302 were studied using an automated arc welding apparatus as discussed above in Example 1. Amperage and voltage measurements were recorded for each sample during testing at approximately 415-417 times per minute, and the effective CTWD was monitored. For all welding samples and conditions studied, there was little difference in amperage decline between samples. Specifically, the Unclad 316LSi sample exhibited a 7.5 amp drop after one hour, while the Cu-Coated 302 sample exhibited a 9.9 amp after one hour.

Following the welding runs, contact tip wear was quantified by measuring the change in internal diameter of the contact tip central bore. While the change in amperage was minimal between the Unclad 316LSi and the Cu-Coated 302 welding wires, the Unclad 316LSi exhibited substantial mechanical wear on the contact tip as evidenced by interior diameter. Results are summarized in Table 3.

TABLE 3
Summary of weld performance for Example 2.

| | Welding | | Contact Tip | | | Wear |
|---|---|---|---|---|---|---|
| | Time | Time | Diam. | Diam. | Diam. | Rate |
| Wire Type | (min) | (hr) | (mm) | Incr. (mm) | Incr. (%) | (%/hr) |
| Unclad | 122 | 2.03 | 1.224 | 0.607 | 50 | 24.4 |
| 316LSi | | | | | | |
| Cu-Coated | 78 | 1.3 | 1.312 | 0.269 | 21 | 15.8 |
| 302 | | | | | | |
| Cu-Coated | 113 | 1.88 | 1.243 | 0.214 | 17 | 9.1 |
| 302 | | | | | | |

As shown in Table 3, the percent increase of the bore area over time was much less for the copper-coated wire sample. The rate of diameter increase for the copper-coated samples appears to be 2× to 3× less that the Unclad 316LSi. The results indicate that the copper-coated stainless welding wire compositions disclosed herein may be used to improve contact tip service life when compared to uncoated stainless steel, without substantial changes to welding performance or weld strength.

Therefore, the presently disclosed systems and methods are well adapted to attain the ends and advantages mentioned as well as those that are inherent therein. The particular aspects disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative aspects disclosed above may be altered, combined, or modified and all such variations are considered within the scope and spirit of the present invention. The terms in the claims have their plain, ordinary meaning unless otherwise explicitly and clearly defined by the patentee.

Unless otherwise indicated, all numbers expressing quantities of ingredients, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention.

In some embodiments, the terms “a” and “an” and “the” and similar references used in the context of describing a particular embodiment (especially in the context of certain of the following claims) can be construed to cover both the singular and the plural, unless specifically noted otherwise. In some embodiments, the term “or” as used herein, including the claims, is used to mean “and/or” unless explicitly indicated to refer to alternatives only or the alternatives are mutually exclusive.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more embodiments and can cover other unlisted embodiments. While systems, compositions, and methods may be described herein in terms of “comprising” various components or steps, the methods can also “consist essentially of” or “consist of” the various components and steps.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the present invention and does not pose a limitation on the scope of the present invention otherwise claimed. No language in the specification should be construed as indicating that any non-claimed element is essential to the practice of the present invention.

Groupings of alternative elements or embodiments disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

Having described the embodiments in detail, it will be apparent that modifications, variations, and equivalent embodiments are possible without departing the scope of the embodiments defined in the appended claims. Furthermore, it should be appreciated that all examples in the embodiments are provided as non-limiting examples.

What is claimed is:

1. A welding wire comprising:
a high alloy metal core comprising greater than about 10.5 percent by weight of the high alloy metal core of a component selected from aluminum, bismuth, chromium, molybdenum, chromium/molybdenum alloy, cobalt, copper, manganese, nickel, silicon, titanium, tungsten, vanadium, or a combination thereof; and
a layer surrounding the high alloy metal core, the layer comprising copper or a copper alloy.

2. The welding wire of claim 1, wherein the layer comprises the copper alloy, and wherein the copper alloy includes copper at a percent by weight (wt %) of the copper alloy up to about 99.9 wt %.

3. The welding wire of claim 2, wherein the copper alloy comprises a balance of at least one metal selected from cadmium, chromium, nickel, tin, zinc, or a combination thereof.

4. The welding wire of claim 1, wherein the layer comprises the copper alloy, and wherein the copper alloy includes copper at a percent by weight (wt %) of the copper alloy ranging from about 60 wt % to about 99.9 wt %.

5. The welding wire of claim 1, wherein the high alloy metal core comprises chromium at a percent by weight (wt %) of the high alloy metal core ranging from about 12 wt % to about 18 wt %.

6. The welding wire of claim 1, wherein the high alloy metal core comprises an austenitic stainless steel.

7. The welding wire of claim 1, wherein the high alloy metal core comprises a duplex steel.

8. The welding wire of claim 1, wherein the layer has a thickness in a range of about 0.1 μm to about 100 μm.

9. The welding wire of claim 1, wherein the layer is present at a percent by weight (wt %) of the welding wire ranging from about 0.005 wt % to about 3 wt %.

10. The welding wire of claim 1, wherein the layer comprises about 0.005% to about 5% of a cross-sectional area of the welding wire.

11. A weld deposit produced by the welding wire of claim 1.

12. A welding method comprising:
applying an electrical current sufficient to convert a welding wire to a molten state to produce a molten weld material, the welding wire comprising:
a high alloy metal core comprising greater than about 10.5 percent by weight of the high alloy metal core of a component selected from aluminum, bismuth, chromium, molybdenum, chromium/molybdenum alloy, cobalt, copper, manganese, nickel, silicon, titanium, tungsten, vanadium, or a combination thereof; and
a layer surrounding the high alloy metal core, the layer comprising copper or a copper alloy; and
depositing the molten welding material onto a workpiece.

13. The welding method of claim 12, wherein the welding method comprises at least one of submerged-arc welding (SAW), gas tungsten arc welding (GTAW), gas metal arc welding (GMAW), or a combination thereof.

14. The welding method of claim 12, wherein the layer comprises the copper alloy, and wherein the copper alloy includes copper at a percent by weight (wt %) of the copper alloy up to about 99.9 wt %.

15. The welding method of claim 14, wherein the balance of the copper alloy comprises at least one metal selected from cadmium, chromium, nickel, tin, zinc, or a combination thereof.

16. The welding method of claim 12, wherein the layer comprises about 0.005% to about 5% of a cross-sectional area of the welding wire.

17. The welding method of claim 12, wherein the high alloy metal core comprises chromium at a percent by weight (wt %) of the high alloy metal core ranging from about 12 wt % to about 18 wt %.

18. The welding method of 12, wherein the layer is present at a percent by weight (wt %) of the welding wire ranging from about 0.005 wt % to about 3 wt %.

19. The welding method of claim 12, wherein the high alloy metal core comprises an austenitic stainless steel.

20. The welding method of claim 12, wherein the layer has a thickness ranging from about 0.1 μm to about 100 μm.
